(19) United States
(12) Patent Application Publication
(10) Pub. No.: US 2026/0327071 A1
(43) Pub. Date: Oct. 22, 2026

(54) THERMAL CRACKING OF METHANE OR NATURAL GAS

(71) Applicant: HiTES Holding GmbH, Sulzbach-Rosenberg (DE)

(72) Inventor: Dragan STEVANOVIC, Sulzbach-Rosenberg (DE)

(21) Appl. No.: 18/998,849

(22) PCT Filed: May 26, 2023
(86) PCT No.: PCT/EP2023/064217

§ 371 Date: Jan. 27, 2025

(30) Foreign Application Priority Data
Jul. 27, 2022 (DE) 10 2022 118 858.2

(51) Int. Cl. C01B 3/24

(52) U.S. Cl. CPC C01B 3/24; C01B 2203/0272; C01B 2203/085; C01B 2203/1241

(57) ABSTRACT

A method for the production of hydrogen by thermal cracking of gaseous hydrocarbons, wherein: the hydrocarbon is preheated to a predetermined temperature in a first device for-storing and/or releasing thermal energy, the hydrocarbon gas further is heated in a high-temperature section of the device; by a subsequent combustion of a portion of the hydrogen produced and/or the further heating is caused at least partly an electrically operated heating device, and the product gas is cooled, in particular in a second device for storing and/or re-leasing thermal energy.

### BACKGROUND OF THE INVENTION

The invention relates to a method and apparatuses for the thermal cracking or cracking of gaseous hydrocarbons and in particular of methane molecules in order to produce hydrogen as the main product and pure carbon as a by-product. In addition to methane from natural gas, for example, also bio-methane, e.g. from biogas, can also be used to transform in this way.

In state-of-the-art thermal cracking, hydrocarbon fractions are heated to approx. 450 to 900° C. under pressure (depending on the method). This causes the long hydrocarbon molecules to vibrate so strongly that the hydrocarbon chains break. Short-chain olefinic hydrocarbon molecules are formed.

The term “cracking” is used in the following

Methane cracking is a promising method that has recently been researched. In this method, methane is broken down at high temperatures into its molecular components, namely hydrogen and pure carbon. An important factor is that the reaction does not release any CO2 emissions as it takes place in the absence of oxygen.

The hydrogen produced serves as an energy source, while the carbon is available for commercial use, such as the production of carbon fibres. Alternatively, it can easily be stored for future use. It is known from current research that methane cracking is a viable process and new work results from the applicant, which are as yet unpublished, show that this technology can be applied on an industrial scale.

In order to achieve thermal cracking, very high temperatures (e.g. 1500° C.) and a long residence time (e.g. 1 second) are required, as explained in more detail below. At lower temperatures, the residence time must be extended, or significantly shortened with even higher temperatures.

The method according to the invention achieves a higher efficiency and a higher H₂-yield than the previously known methods and at the same time leads to significantly lower investment costs by avoiding expensive and technologically sophisticated components. Preferably, depending in particular on the type of heating or the type of heating, no climate-damaging CO2 is produced, or at least significantly less than in steam reforming methods, for example.

Hydrogen plays a decisive role in the energy transition, both in Germany and world-wide. As a secondary energy source, hydrogen does not produce any climate-damaging gases during use. Unfortunately, however, the largest amount of hydrogen is currently produced by vapour reforming natural gas. This produces up to 13 kg of CO2 per kilogramme of hydrogen produced. For this reason, this H₂ is referred to as “grey” hydrogen.

Hydrogen from renewable energies is the right solution, but currently plays a very minor role, not least because of its high cost. The best-known method is the electrolysis of water using electricity from renewable energy. There are various electrolysis processes with different levels of efficiency, meaning that up to 60 kWh of electricity is required to produce 1 kg of H₂. Hydrogen produced in this way is referred to as “green”. If the electricity comes from nuclear power, i.e. is also CO2-neutral, the term “red” hydrogen is used.

A further option is to obtain the hydrogen from biomass, usually using a gasification process. Other processes such as torrefaction, pyrolysis or fermentation are also, albeit with lower utilisation of the input material. In principle, this is also “green” hydrogen, as no additional quantities of CO2 are produced. Unfortunately, also due to many mistakes in the recent past, biomass has a bad image, so that some authors describe the hydrogen obtained in this way as “orange”.

In order to produce larger quantities of hydrogen under acceptable cost conditions, attempts are made to produce it again from fossil natural gas, but without CO2 emissions into the atmosphere. The known vapour reforming processes can still be used, but with the CO₂ being separated from the exhaust gases and deposited in underground caverns. This process is also controversial, especially as there is no long-term experience with so-called CCS (Carbon Capture and Storage) technologies.

Hydrogen obtained in this way is referred to as “blue”.

Another possibility is the splitting or cracking of the methane molecule as the main component of the natural gas. This produces hydrogen and pure solid carbon, according to the equation:

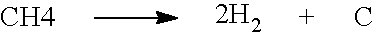

The heat of reaction required for the endothermic reaction is 74.9 kJ/mol. The storage or utilisation of solid carbon is much simpler and more attractive, which speaks in favour of such methods. Hydrogen produced in this way is known as “turquoise”.

Methods with catalytic cracking enable a significantly lower temperature (see Schneider et al., Verfahrensübersicht zu Erzeugung von Wasserstoff durch Erdgas-Pyrolyse, Chemie Ingenieur Technik, 92, No. 8, 2020).

The first development has been discontinued because the reactivation of the catalyst results in high costs and carbon dioxide is released into the atmosphere.

There are also several developments that use plasma fission. The company Kvaerner has tested such a process (see above, as well as the patent DE 692 08 686.2) and discontinued development in 2003 due to insufficient quality of the thermal carbon black. There are several other developments with plasma methods, some up to TRL 8, which require significantly less electrical energy than electrolysis. However, all of these methods require significantly higher amounts of energy than the theoretical reaction heat of methane decomposition.

There are several methods for the thermal cracking of methane, or hydrocarbons in general. Some use the externally or internally obtained carbon as a catalyst to accelerate the cracking reaction or reduce the reaction temperature somewhat, as described, for example, in patent specification U.S. Pat. No. 6,670,058 B2. There, a quantity of the inlet gas is burnt with air and this energy is used to preheat the carbon particles to high temperatures. The preheated carbon particles are fed to a reactor to enable the endothermic reaction.

Patent specification WO 2013/004398 A2 describes a method in which the splitting takes place in a reaction chamber in the presence of carbon-containing granulate.

The necessary heat is again obtained by combustion of a tail gas in an external combustion chamber and introduced into the reaction chamber by superheating part of the product gas (hydrogen) in an external heat exchanger.

An advantageous superheating temperature in the range 1100° C. to 1400° C. has been mentioned, but without explaining the means by which such superheating can be realised. According to the state of the art, the maximum temperatures for certain heat exchangers such as recuperative heat exchangers are in a range slightly above 900° C., i.e. anything above 1000° C. is currently not possible to realise, which has a considerable negative impact on the degree of conversion and the quality of the product (hydrogen and/or carbon).

Patent specification EP 3 521 241 A1 describes a method for the thermal/catalytic cracking of methane in a metal bath made of tin. The bath is thermally heated to 900° C.-1200° C. and the methane enters through a structure with nozzles under the bath. Bubbles of methane are formed, which split to H₂ and C due to the high temperature and long residence time. A layer of carbon is formed on the upper surface of the bath, which grows continuously over time and must therefore be removed periodically. According to the information in the patent specification, the power consumption is 7.5 kWh/kg H₂, which is significantly lower than for water electrolysis, but still 30% higher than the theoretical energy requirement for the endothermic reaction. It is also stated that the degree of conversion of the methane is only 58.6%, which is due to the excessively low temperature of 1100° C. It is not shown or discussed how the design and material selection of the thermal heaters are organised. Furthermore, it is not described how to deal with the waste heat at temperatures above 1100° C. and how this affects the energy balance or the efficiency of the system.

In another article on this method (Geißler T. et al., Hydrogen production via methane pyrolysis in a liquid metal bubble column reactor with a packed bed, Chemical Engineering Journal 299 (2016) 192-200), an H₂ yield of up to 78% at a bath temperature of 1175° C. is reported. There it is shown that the electrical energy used to maintain the temperature of the tin bath. Also in the current web presentation of the project (https://www.kit.edu/kit/pi_2019_wasserstoff-aus-erdgas-ohne-co2-emissionen.php)) does not provide better values for the H₂ yield either.

### AIM OF THE INVENTION

The present invention is therefore based on the object of providing an apparatus and a method which enable a cracking of gaseous hydrocarbons and, in particular, methane. In addition, an efficiency in the production of hydrogen is to be increased.

The present invention has also set itself the object of providing a method and an apparatus for splitting gaseous hydrocarbons, such as methane, in which the investment costs are lower and the efficiency higher than in the state of the art. The hydrogen produced in this way becomes significantly cheaper when the costs for the land-filling or storage of carbon dioxide are also taken into account.

A further object is to consume significantly less energy for fission than the competing processes. At the same time, investment costs are to be significantly reduced avoiding technically demanding and expensive components, such as plasma torches and recuperative high-temperature heat exchangers, and by using more compact and cost-effective components.

### SUMMARY OF THE INVENTION

The method described here is particularly suitable for the use of methane or natural gas as an input material, but any gaseous hydrocarbons can also be used.

In a method according to the invention for producing hydrogen by thermal cracking of gaseous hydrocarbons at temperatures above 1000° C., at least one heating device is provided for storing or releasing thermal energy.

According to the invention, the hydrocarbon is first heated and in particular preheated and in particular preheated to a predetermined reaction temperature in said heating device.

In a further method step, the preheated hydrocarbon and/or in particular a product gas produced from the hydrocarbon (in particular by cracking) is heated further or the hydrocarbon and/or the product gas produced from the hydrocarbon is heated further and/or the product gas is heated again, in particular in a reaction chamber and/or high-temperature section of the apparatus.

This heating takes place at least partially by a supply (and in particular an injection) of oxygen into the high-temperature zone and preferably a subsequent combustion of part of the hydrogen produced and/or the further heating is effected by an electrically operated heating device.

The cracking process, which is an endothermic reaction, causes the product gases to cool down. These are preferably reheated after the carbon has been separated.

This reheating is particularly preferable in order to be able to release heat again in the second device for storing heat, so that continuous operation can be guaranteed this way.

Oxygen is preferably injected at a pressure of between 2 bar and 200 bar.

In a further method step, the product gas is cooled, in particular in a second device for storing and/or releasing thermal energy.

Preferably, the heating device for storing and/or releasing thermal energy in the broadest sense is a heat exchanger which interacts in particular with a fluid flowing through it, in particular a gas or vapour, wherein, depending on the temperatures of this fluid and the heating device, either thermal energy is released from the fluid to the heating device or, conversely, the heating device heats this fluid.

Preferably, this heating device has a supply device for supplying a fluid and also a discharge device for discharging the fluid, which is in particular gaseous hydrocarbon or hydrogen mixtures.

A method is proposed in which two heating devices are provided, which are operated alternately in particular. One of the two heating devices is preferably used to preheat the gaseous hydrocarbons and the other heating device is used to cool the process gas, i.e. hydrogen.

These two heating devices are preferably operated alternately, which means that when one of the heating devices heats the hydrocarbons, the second heating device simultaneously cools the resulting process gas. The advantage of this procedure is that the corresponding heating device itself is reheated to a certain extent by the process gas. In this way, a continuous process is possible with the appropriate valve circuitry.

Particularly preferably, the gaseous hydrocarbons are preheated to a temperature that is greater than 1000° C., preferably greater than 1500° C. Preferably, the gaseous hydrocarbons are preheated to a temperature of less than 1800° C., preferably less than 1600° C.

Preferably, the further heating and/or reheating of the process gas takes place as mentioned above, either by an electrical heating device or by a supply of oxygen and combustion of some of the hydrogen already formed. It is also possible that this further heating is achieved by several processes, for example both electrical heating and a supply of oxygen. It may be possible, for example, that at the start of a process, heating is initially predominantly electrical and that in a further stage of the process, further heating is predominantly achieved by partial combustion of hydrogen.

Particularly preferably, electrical heating and combustion heating are therefore proportionately, wherein these proportions can change during working operation.

Particularly preferably, the carbon-containing gases in the high temperature section are heated to a temperature greater than 1000° C., preferably greater than 1100° C., preferably greater than 1200° C., preferably greater than 1300° C., preferably greater than 1400° C. and preferably greater than 1500° C.

In a further preferred method, a residence time of the carbon-containing gases in the high temperature section is greater than 0.1 s, preferably greater than 0.2 s, preferably greater than 0.3 s, preferably greater than 0.4 s and particularly preferably greater than 0.5 s.

In a further advantageous embodiment, a residence time of the gases in the high temperature section is less than 40 s, preferably less than 30 s, preferably less than 20 s, preferably less than 15 s and particularly preferably less than 10 s and preferably less than 5 s and preferably less than 3 s.

These precisely defined residence times enable particularly efficient cracking of the hydrocarbon to be achieved.

Preferably, a residence time of the hydrocarbons in the high-temperature section is controlled and, in particular, controlled as a function of at least one further process parameter. For example, the flow rate can be controlled (by the valves), but the system can also be designed accordingly (e.g. by appropriately dimensioning the pipes) in order to achieve the desired residence time.

This control is preferably carried out by valve devices that are controlled accordingly. Preferably, the further process parameter is a temperature and in particular a temperature of the hydrocarbon gases in the high-temperature section and/or a temperature of the high-temperature section itself.

In a further preferred method, at least two devices for storing and/or releasing thermal energy are operated alternately.

Particularly preferably, at least one of these apparatuses for storing and/or releasing thermal energy is a so-called bulk material generator. These have a bulk material which is used for heat exchange with a further medium, in this case the respective gases.

In a further preferred process, methane (CH₄) is used as the gaseous hydrocarbon. It has been shown that methane is particularly suitable for the cracking processes described here.

Particularly preferably, the gaseous hydrocarbons are heated to temperatures of over 1500° C. and particularly preferably split at this temperature.

In a preferred method, the preheated gaseous hydrocarbons are conveyed to the high-temperature section. This is preferably done with the aid of pipelines and by controlling valves accordingly.

In a further preferred method, carbon is deposited and, in particular, carbon is deposited in the form of a fine powder. Carbon is particularly preferably deposited in a separation device, which is arranged after and/or between the high-temperature tongues.

In a further preferred method, oxygen is added to the heated product, in particular after carbon has been removed, in particular to further and/or reheat the product gas, as mentioned above. Particularly preferably, this supply of oxygen takes place after the separation device described above.

In a further preferred method, a gas mixture, in particular a resulting gas mixture, is cooled and preferably this cooling is carried out in order to separate water produced by the combustion from hydrogen. Particularly preferably, this cooling takes place in a condenser.

Particularly preferably, cooling to a temperature of less than 50° C., particularly preferably less than 20° C. In particular, the gas mixture to be cooled is a mixture of hydrogen and water, or more precisely hydrogen and water vapour.

The present invention is further directed to an apparatus for producing hydrogen by thermal cracking of gaseous hydrocarbons, which has at least two devices for storing and/or releasing thermal energy. Each of these two devices is suitable and intended both for preheating the gaseous hydrocarbons and for cooling a product gas, in particular hydrogen, produced during the cracking.

Preferably, the two devices for storing and/or releasing thermal energy are separated from each other and, in particular, spaced apart.

Particularly preferably, the apparatus has at least one high-temperature section which can be brought into flow connection with each of the devices for storing and/or releasing thermal energy in such a way that a gaseous hydrocarbon preheated by this device is further heated and/or can be heated in this high-temperature section and/or a product gas entering this high-temperature section is reheated or can be reheated, wherein the apparatus having a heating device which effects the heating of the gaseous hydrocarbons in the high-temperature section.

As mentioned above, the storage devices can be so-called bulk material regenerators. Preferably, the storage device has a receiving chamber that is suitable and intended for receiving a bulk material.

Preferably, this high-temperature section is arranged downstream of the heating device in a flow direction of the gaseous hydrocarbons. In a preferred embodiment, the apparatus has at least two high-temperature sections. In a further preferred embodiment, the apparatus has a high-temperature section which can be brought into flow connection with both heating devices.

Particularly preferably, the high-temperature section is suitable and intended for heating a gas and in particular the gaseous hydrocarbons to a temperature which is greater than 1000° C., preferably greater than 1100° C., preferably greater than 1200° C., preferably greater than 1300° C., preferably greater than 1400° C. and particularly preferably greater than 1500° C.

Particularly preferably, the apparatus has a separation device for separating carbon from the heated hydrocarbons or the carbon-hydrogen mixture, wherein this separation device can preferably be brought into flow connection with a high-temperature section and preferably with two high-temperature sections.

In a preferred embodiment, it is possible that the separation device is located downstream of at least one high-temperature section and preferably both high-temperature sections (in the direction of flow of the gaseous hydrocarbons and/or the product gas). It is thus possible for this separation device to be located essentially in the centre of a high-temperature section considered in its entirety or of the two high-temperature sections.

Preferably, the high-temperature section is a section in which gaseous hydrocarbons are heated even further, in particular after they enter the high-temperature section already preheated.

In a further advantageous embodiment, the heating device has an electrically operated heating unit and/or the heating device has a supply line for supplying oxygen to the high-temperature section. In the second embodiment, combustion of a portion of the hydrogen can take place with the aid of this oxygen.

As described above, two procedures are thus proposed to further heat the hydrocarbons and/or to reheat the product gas, namely on the one hand an electrical heating means and on the other hand the supply of oxygen, in particular to burn the hydrogen-oxygen mixture and in this way generate further thermal energy or heat. Particularly preferably, the apparatus has a control device which controls the operation of the device and which in particular causes the above-mentioned heating devices to be operated alternately.

This means that one of the two heating devices preheats the gaseous hydrocarbons during a certain period of time and then the product gas resulting from the cracking process is heated further and the second device cools the resulting process gas, in particular hydrogen, during this period of time. In this way, continuous operation can also be achieved.

In a further time period, the other of the two heating devices preheats the gaseous hydrocarbons and then these preheated hydrocarbons are heated further and/or the resulting product gas is heated again and in this further time period the second device cools the resulting process gas, in particular hydrogen. In this way, continuous operation can also be achieved.

In a preferred embodiment, the high-temperature section is designed such that a residence time of the gaseous hydrocarbons in this section is greater than 0.1 s, preferably greater than 0.2 s, preferably greater than 0.3 s, preferably greater than 0.4 s and preferably greater than 0.5 seconds.

Particularly preferably, the said section is designed in such a way that a residence time of the gaseous hydrocarbons in this section is less than 60 s, preferably less than 50 s, preferably less than 40 s, preferably less than 30 s, preferably less than 20 s, preferably less than 10 s, preferably less than 8 s, preferably less than 6 s, preferably less than 5 s, preferably less than 4 s and preferably less than 3 s.

In a further advantageous embodiment, at least one high-temperature section is designed as a line and, in particular, a pipeline.

Preferably, the pipeline is made of a material selected from a group of materials containing Mulit or, even better, pure Alumina.

In a further advantageous embodiment, the separation device has a receiving chamber filled with a bulk material and in particular with a ceramic bulk material. In this way, the separation device can also work in such a way that the gas to be cleaned flows through this separation device and carbon is separated or removed in this way.

In a further advantageous embodiment, the separation device has deflection means which cause the incoming gas to change its direction of flow at least once and preferably several times as it flows through the bulk material.

These deflection means can formed by the bulk material itself.

Carbon is furthermore produced through the thermal cracking of methane or other gaseous hydrocarbons. Hydrogen produced in this way is significantly cheaper than hydrogen produced by electrolysis. If the carbon is not used as a fuel, this hydrogen is just as environmentally friendly and climate-neutral as the H₂ produced by using renewable energies. It is also proposed to use carbon from biomass instead of cracking fossil hydrocarbons in order to achieve negative CO2 emissions.

In a further method according to the invention, the energy required to reach the reaction temperature (e.g. 1500° C.) is already stored inside a reactor and further utilised for superheating the gas. The reaction heat is also generated inside the reactor, in particular directly in a high-temperature zone. There are two preferred ways of generating this heat:
by oxygen injection and post-combustion of a small amount of hydrogen and/or other cracking products, and/or
by electric heating, with high-temperature heating elements preferably placed directly in the high-temperature zone.

In this way, the energy consumption is only reduced to a physically necessary amount, despite the very high temperatures in the reaction zone.

Preferably, one storage device and preferably at least two storage devices are used to store the high-temperature heat for superheating the inlet gas and cooling the product gas. Preferably, this is a regenerator and particularly preferably a bulk material regenerator.

Particularly preferably, this bulk material regenerator has a heat storage mass of bulk material which is arranged within a container and which is particularly preferably arranged within two mutually coaxial cylindrical grids, as described in patent specification DE 42 36 619 C2 and EP 0 620 909 B1. The disclosure content of these two patent specifications is hereby fully incorporated by reference into the present disclosure.

Preferably, the inner of these two grates surrounds a hot collecting chamber for the hot gases. A circumferential wall is preferably arranged around the outer cylindrical grate and, particularly preferably, a collecting space for cold gases is provided between the outer cylindrical grate and this wall.

In a further preferred embodiment, axially and/or vertically flowing bulk material are provided, which are particularly advantageous for smaller systems.

Particularly preferably, the heat storage mass has a spherical bulk material that can also withstand very high temperatures. Preferably, various ceramic or natural materials are used, particularly advantageous are the spheres made of Alumina, which can be used up to 1700° C. and still have a very good price/performance ratio.

In a further preferred method, the grain size of the bulk material is smaller than 30 mm, preferably smaller than 25 mm, preferably smaller than 20 mm and particularly preferably smaller than 15 mm. Preferably, the grain size of the bulk material is greater than 0.5 mm, preferably greater than 2 mm.

Preferably, the reaction temperatures in the connecting tube between two devices for storing and releasing thermal energy are above 1000° C., particularly advantageously above 1500° C. The length and diameter of the connecting tube is selected so that the reaction volume ensures a predetermined residence time corresponding to the reaction temperature. For a temperature of 1500° C., the residence time should be at least 1 second. For even higher temperatures, a shorter residence time is possible and vice versa; for lower temperatures, the residence time should be significantly longer. In this way, sufficient time is given for the complete cracking of the methane. In a test plant for 2 to 4 m³/h CH4, an H2 yield more than 94% has already been achieved.

Between the two devices for storing and releasing thermal energy, a device for carbon separation is particularly preferably arranged approximately in the centre of a connecting tube—in a further preferred method. Particularly advantageous, this apparatus is to be filled with ceramic bulk material, e.g. Alumina.

Hydrogen-containing gas, which contains soot particles, will change its flow direction, preferably several times, and most of the carbon will be separated in the process. This preferably forms a filter cake, which then filters the carbon even more effectively. This apparatus is preferably emptied continuously or periodically after a certain time.

By replacing this bulk material with deposited carbon dust, it is preferable to prevent a large accumulation and thus avoid excessive pressure loss.

During the process, carbon may be separated that cannot be removed one hundred percent. A smaller amount of carbon can accumulate in the higher areas of the bulks in the devices for storing and releasing thermal energy. In a preferred method, this bulk is also periodically circulated and/or recirculated to remove the deposited soot, so that a larger accumulation of carbon is prevented.

These accumulations of carbon on bulk material and in the carbon separation device preferably also serve as a catalyst for the cracking reactions. Therefore, in a preferred method, this removal of carbon should not be too intensive. It is advantageous to always leave a small amount of carbon black in the system.

In a further preferred embodiment, the apparats for separating carbon has a partition wall which separates at least a part of an interior space of the apparatus into two partial rooms. Preferably, the partition wall is designed or ends inside the apparatus in such a way that the two partial rooms are connected to each other below the partition wall.

Preferably, the apparatus has a first feed device for feeding bulk material to the apparatus for separating carbon. Preferably, the apparatus has a second feed device for feeding bulk material to the device for removing carbon.

Preferably, the first feed device and the second feed device can be operated separately from each other. Preferably, the first feeding device and the second feeding device are separate from each other.

Preferably, the first feed device opens into a first partial room of the apparatus for separating carbon and the second feed device opens into a second partial room of the apparatus for separating carbon.

Preferably, the apparatus has a first discharge device for discharging bulk material from the apparatus for separating carbon. Preferably, the apparatus has a second discharge device for discharging bulk material from the apparatus for separating carbon.

Preferably, the first discharge device and the second discharge device can be operated separately from one another. Preferably, the first discharge device and the second discharge device are separate from each other.

Preferably, at least one feed device and/or at least one discharge device and preferably several and preferably all feed devices and discharge devices have a valve device which controls the flow of bulk material.

In a further preferred method, oxygen for the generation of the consumed reaction heat is blown in for the first time after the apparatus for the carbon particles, so that preferably the post-combustion takes place almost exclusively with a portion of the hydrogen generated, or so that no CO or CO2 is produced.

In a further preferred method, it is provided that the necessary reaction heat is generated by electrical energy instead of or in addition to the oxygen. The corresponding high-temperature heating elements are preferably arranged in the reaction chamber from at least one side and preferably from both sides of the apparatus for carbon separation.

In a further advantageous method, a condenser is used to remove the water vapour contained in the product gas, which contains a lot of hydrogen. This water vapour is produced by oxidation of the hydrogen, in particular if the oxygen is used to recover the heat of reaction. The condensate from the condenser also contains a small amount of soot particles and can preferably be used to pelletise the soot from the system. If this water is not required after filtration, it can be discharged.

The hydrogen produced may contain other very fine carbon particles. For this reason, a fine particle filter is advantageously provided downstream of the system. If very pure hydrogen is required, e.g. for use in fuel cells or in carbon fibres, a PSA or membrane technology system can also be provided in order to completely remove any gases such as methane, CO, CO2 or H2O that may be present.

### BRIEF DESCRIPTION OF THE DRAWINGS

The patent application is described in detail with reference to the description and FIGS. 1 to 3. In the drawings:

FIG. 1 shows a schematic representation of the method with generation of the necessary reaction heat inside the reaction chamber by oxygen injection, according to the invention;

FIG. 2 shows a method diagram according to the invention, wherein the necessary reaction heat is generated by electric heating inside the reaction chamber; and

FIG. 3 shows an advantageous design of the apparatus for the separation of carbon.

### DETAILED DESCRIPTION OF THE INVENTION

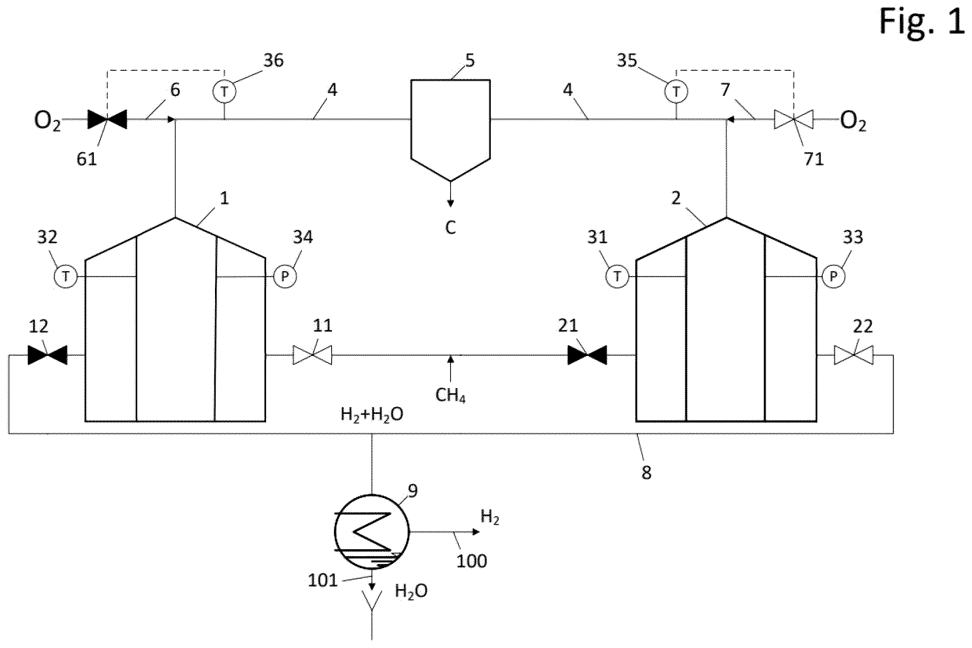

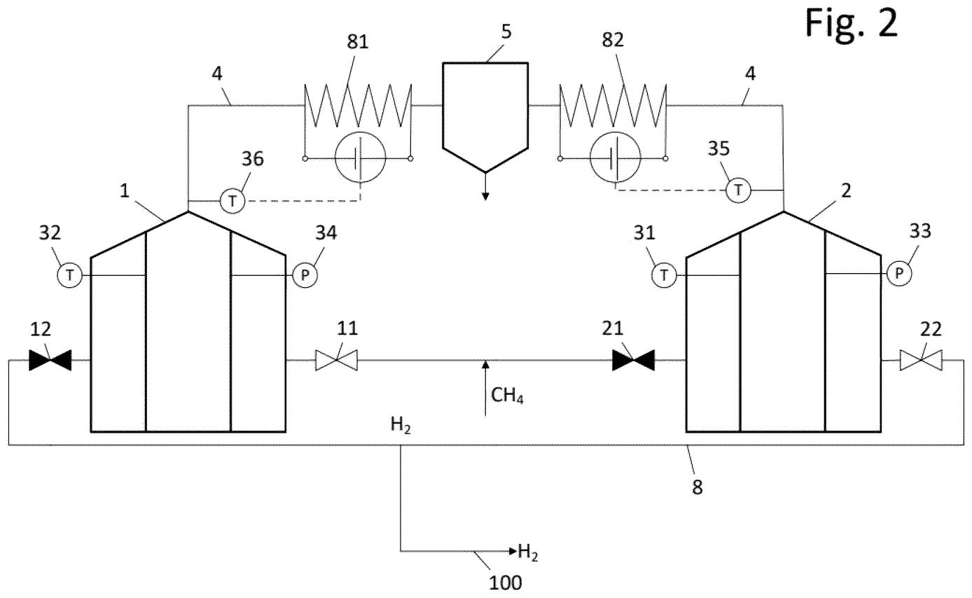

According to the embodiments of the present invention shown in FIG. 1 and FIG. 2 for cracking the methane into hydrogen and carbon, at least two devices 1, 2 are used alternately for storing and releasing thermal energy, wherein the gaseous hydrocarbons and in particular the methane flowing through one device and the hydrogen obtained through the second device.

The switching elements that cause the direction of flow through the system to change are also shown. These are valves 12, 11, 21 and 22. In FIG. 1, the closed valves are shown in black and the open valves are shown without black filling. Thus, in the situation shown in FIG. 1, the device 1 is used to heat or preheat methane and the device 2 is used to cool the resulting product gas, in particular a mixture of hydrogen and, for example, water.

The reference signs 31, 32, 33 and 34 identify measuring devices that measure the states of the hydrocarbons. For example, the measuring devices 31 and 32 may be temperature measuring devices which measure the temperature of the hydrocarbons in the device 1 and the device 2, and the measuring devices 33 and 34 may be pressure measuring devices.

The reference sign 36 and the reference sign 35 each identify a temperature measuring device for determining a temperature of the hydrocarbons in a high-temperature section 4.

FIG. 1 shows a method diagram and the arrangement of the apparatuses, wherein, for example, the methane (or another gaseous hydrocarbon) enters the first device 1 through the open valve 11. There, the methane is heated from the inlet temperature (e.g. 20° C.) to reaction temperature (e.g. 1500° C.) by the heat that was stored in the previous cycle.

The preheated methane enters a high-temperature connecting pipe 4 between devices 1 and 2.

Very intensive methane cracking occurs there, resulting in a corresponding drop in temperature. In the high-temperature connecting pipe 4 downstream of the carbon ash separator 5 in the direction of flow, the temperature rises again due to the oxygen injection and the oxidation of part of the hydrogen previously produced.

Due to the very high temperatures, intensive cracking begins immediately and hydrogen and carbon are produced. In the centre of line 4, between the devices 1 and 2, an additional device 5 is provided for removing the carbon produced.

Gas flowing downstream of device 5 in the direction of device 2 contains practically no carbon, only the fine soot particles. Due to the endothermic cracking reaction, the temperature of the gas drops significantly. To compensate for these temperature losses, oxygen is injected through the line 7. This oxygen usually reacts with hydrogen, as the methane cracking is practically complete, and the temperature of the gas rises again.

The control valve 71 is used to regulate that the same reaction temperature pre-vails again at the inlet to device 2. The mass flow rate of the gas mixture H2+H2O is lower than that of methane at the system inlet due to the separation of carbon. The outlet temperature at valve 22 and through line 8 is approx. 5 to 200 K higher.

In order to condense water vapour and remove the condensate, a condenser 9 and/or a drainage 101 is preferably provided. The almost pure hydrogen escapes through the line 100. If a purity similar to that required for the fuel cell is desired, the remaining soot particles are preferably removed in an optional downstream particle filter.

In addition, an optional separation system (PSA or membrane technology) is provided to remove any remaining gases such as CH₄, CO, CO₂ or H₂O.

After a preset time interval, the switching elements 11, 12, 21 and 22 change their position and the gas flows from device 2 towards device 1. The control valve 71 closes and the oxygen is injected through line 6 and control valve 61.

FIG. 2 shows an alternative in which the consumed heat of reaction is not introduced into the system by hydrogen combustion with the injected oxygen, but by electrical energy. As in the previous case, the methane (or another gaseous hydrocarbon) enters the first device 1 through the open valve 11, where the methane is heated from the inlet temperature (e.g. 20° C.) to reaction temperature (e.g. 1500° C.) by the heat that was stored in the previous cycle. The preheated methane enters a high-temperature connecting pipe 4 between the devices 1 and 2. Due to the very high temperatures, intensive cracking begins immediately and hydrogen and carbon are produced.

In the centre of line 4, between devices 1 and 2, an additional device 5 is again provided for removing the carbon produced. Gas flowing into device 2 after device 5 contains practically no carbon, only the fine soot particles. Due to the endothermic cracking reaction, the temperature of the gas is significantly reduced. To compensate for these temperature losses, the gas is heated with an electric heater 81 downstream of device 1 and again with an electric heater 82 up-stream of device 2.

The power of these heaters is controlled by the corresponding temperature measurements, so that a practically constant reaction temperature (e.g. 1500° C.) is maintained in the entire pipe 4. The heaters 81 and 82 are preferably integrated directly into the gas tube.

This produces no water vapour and no carbon oxides, which is very advantageous for the rest of the process. The disadvantage is that the mass flow rate of the gas (in this case only H₂) is even lower than that of methane at the plant inlet due to the separation of carbon.

The outlet temperature at valve 22 and through line 8 rises by more than approx. 5 to 200 K. The water vapour condenser and the drainage are preferably omitted here. The pure hydrogen escapes through line 100.

If a purity similar to that required for the fuel cell is desired, the remaining soot particles can be removed in a downstream particle filter. After a certain time interval, the switching elements 11, 12, 21 and 22 change their position and the gas flows from device 2 into device 1.

Instead of using only two bulk material regenerators 1 and 2, 3 or more bulk material regenerators can be used to achieve particularly even operation and to integrate a flushing phase when switching over.

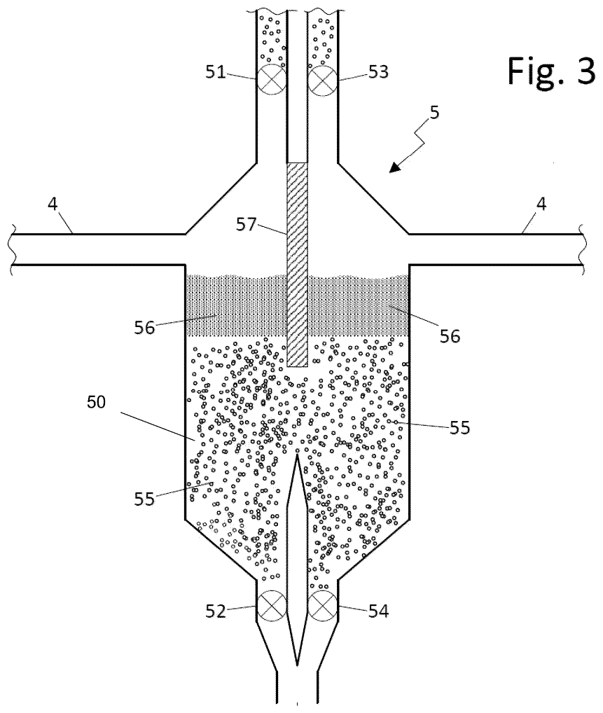

FIG. 3 shows a device 5 for separating the carbon particles that arrive through the high-temperature line 4, mixed with the hydrogen. The device 5 is filled with a—preferably ceramic-bulk material 55.

The reference sign 50 identifies a receiving space formed inside the apparatus for receiving the bulk material. The reference sign 57 refers to a partition wall which divides the receiving space of the apparatus into two subspaces in an upper area.

The bulk material protrudes slightly beyond the lower end of the partition wall 57. In this way, the incoming gas is forced to flow through the two halves of the bulk material chamber.

The carbon particles settle, most of them immediately on the surface of the bulk material, where they form a so-called filter cake 56. The filter cake 56 intensifies further separation of the carbon particles and acts preferentially as a catalyst for the further cracking of any methane molecules still present.

The carbon particles form a very porous and permeable structure that generates little pressure loss. This is why the filter cake is not destroyed even when the flow direction is reversed, from bottom to top, and most of the particles remain there.

If the layer of carbon particles 56 becomes very high, the separator 5 must be emptied. For this purpose, the bulk material valve (or airlock) 52 is preferably opened until the entire left part is empty. Then the valve 52 is closed again and the upper valve 51 is opened to let in the new quantity of bulk material and refill the left part.

This can be done during operation of the system, as the right-hand half is still present and act alone for a short time for separation. With a slight time delay, the same procedures are also carried out with the right-hand part of the separator by actuating valves 54 and 53.

The applicant reserves the right to claim all features disclosed in the application documents as being essential to the invention, provided that they are new compared to the prior art, either individually or in combination. It should also be noted that the individual figures also describe features which may be advantageous in themselves. The person skilled in the art immediately recognises that a certain feature described in a figure can also be advantageous without the adoption of further features from this figure. Furthermore, the skilled person recognises that advantages can also result from a combination of several features shown in individual figures or in different figures.

### LIST OF REFERENCE SYMBOLS

1 first device for storing and releasing thermal energy
2 second device for storing and releasing thermal energy
3 possible third device for storing and releasing thermal energy
4 high temperature line
5 apparatus for the separation of carbon
6 first pipe for the injection of oxygen
7 second pipe for the injection of oxygen
8 outlet line
9 capacitors
11 switching element at the inlet of the first device for storing and releasing thermal energy
12 switching element at the outlet of the first device for storing and releasing thermal energy
21 switching element at the inlet of the second device for storing and releasing thermal energy
22 switching element at the outlet of the second device for storing and releasing thermal energy
51-54 bulk material valve/airlock
55 bulk material in the coal separator
56 separated coal separators
57 partition wall
61 first control valve for oxygen
62 second control valve for oxygen
81 first electric heater
82 second electric heater
84 second electrical control unit
100 outlet line of the hydrogen
101 condensate drainage

1. A method for the production of hydrogen by thermal cracking of gaseous hydrocar-bons at temperatures above 1000° C., wherein at least one device for storing and/or releasing thermal energy is provided, wherein:
the hydrocarbon is heated and/or preheated to a predetermined temperature in the device for storing and/or releasing thermal energy, in particular to a reaction temperature,
the hydrocarbon and/or the product gas resulting from the carbon is heated in a high temperature section, wherein
this further heating is effected at least in part by a supply of oxygen to the high-temperature section and subsequent combustion of a portion of the hydrogen produced and/or the further heating is effected at least in part by an electrically operated heating device, and
the product gas is cooled, in particular in a second device for storing and/or re-leasing thermal energy.

2. The method according to claim 1, wherein
a residence time of the gases and/or the gaseous hydrocarbons in the high-temperature section is greater than 0.1 s, preferably greater than 0.2 s, preferably greater than 0.3 s, preferably greater than 0.4 s and particularly preferably greater than 0.5 s and/or a residence time of the gases in the high-temperature section is less than 40 s, preferably less than 30 s, preferably less than 20 s, preferably less than 15 s and particularly preferably less than 10 s.

3. The method according to claim 1, wherein
at least two devices are provided for storing and/or releasing thermal energy, which are preferably operated alternately.

4. The method according to claim 1, wherein
methane is used as the gaseous hydrocarbon.

5. The method according to claim 1, wherein
the gaseous hydrocarbons are cracked at temperatures above 1500° C.

6. The method according to claim 1, wherein
carbon is separated.

7. The method according to claim 1, wherein
the oxygen is supplied and/or the product gas is heated after the carbon has been re-moved, in particular in a separator.

8. The method according to claim 1, wherein
a gas mixture, in particular a resulting gas mixture, is cooled in order to separate the water produced by the combustion from hydrogen, wherein this cooling preferably taking place in a condenser.

9. An apparatus for producing hydrogen, in particular by thermal cracking of gaseous hydrocarbons, having at least two devices for storing and/or releasing thermal energy, wherein each of the two devices being configured for both preheating the gaseous hydrocarbons and for cooling a product gas produced during cracking, wherein
the apparatus has at least one high-temperature section which configured to be brought into flow connection with each of the devices for storing and/or releasing thermal energy in such a way that a gaseous hydrocarbon preheated by this device and/or a product gas is heated in this high-temperature section, wherein the apparatus having a heating device which effects the heating of the gaseous hydrocarbon in the high-temperature section.

10. The apparatus according to claim 9, wherein
the apparatus has a separation device configured for separating carbon from the heated hydrocarbons, wherein preferably this separation device is configured to be brought into flow connection with the high-temperature section.

11. The apparatus according to claim 9, wherein
the apparatus has at least two separate high-temperature sections, which are configured to preferably alternately heat the gaseous hydrocarbons and/or the product gas further.

12. The apparatus according to claim 9, wherein
the heating device has an electrically operated heating unit and/or the heating device has a supply line for supplying oxygen to the high-temperature section.

13. The apparatus according to claim 9, wherein
the high-temperature section is designed such that a residence time of the gaseous hydrocarbons in this section is greater than 0.1 s, preferably greater than 0.2 s, preferably greater than 0.3 s, preferably greater than 0.4 s and particularly preferably greater than 0.5 s and/or a residence time of the gases in the high-temperature zone is less than 40 s, preferably less than 30 s, preferably less than 20 s, preferably less than 15 s and particularly preferably less than 10 s.

14. The apparatus according to claim 9, wherein
at least one high-temperature section is configured as a line and in particular as a pipe.

15. The apparatus according to claim 9, wherein
the separation device has a receiving chamber filled with a bulk material and in particular with a ceramic bulk material and/or the separation device has a deflector which is configured to cause the inflowing gas to change its direction of flow at least once and preferably several times as it flows through the bulk material.
